(19) United States
(12) Patent Application Publication
(10) Pub. No.: US 2016/0348794 A1
(43) Pub. Date: Dec. 1, 2016

(54) SAFETY GLOBE VALVE & METHOD TO PREVENT ACCIDENTAL VALVE OPENINGS

(71) Applicant: Paddy Shane Caldwell, Summerland (CA)

(72) Inventor: Paddy Shane Caldwell, Summerland (CA)

(21) Appl. No.: 14/722,420

(22) Filed: May 27, 2015

(51) Int. Cl. F16K 3/30; F16K 31/44; B23P 15/00; F16K 17/00

(52) U.S. Cl. CPC F16K 3/30; F16K 17/003; F16K 31/44; B23P 15/001

(57) ABSTRACT

The invention is directed to a safety globe valve having a housing and a stem. The stem is disposed within a hollow interior of the housing and disposed in a safety orientation. The safety orientation includes at least first stem member in spaced apart relation to at least second stem member. The stem can be also disposed in an operative orientation. The operative orientation includes at least first stem member temporarily connected to at least second stem member. At least first member of the stem is structured to retract in opposite direction of at least second stem member, upon disposing the stem in the safety orientation. At least first stem member is structured to advance in direction of at least second stem member, while disposing the stem in the operative orientation. The invention is also directed to a method to prevent accidental valve openings.

### BACKGROUND OF THE INVENTION

Field of the Invention

This invention generally relates to gate valves for oil and gas production, but are not limited to such areas. More specifically, a safety gate valve to promote safety by monitoring the flow of fluids and by preventing accidental openings in pressurized environments.

Description of Related Art

Safety gate valves are used in many industrial applications including mining, power generation, oil and gas production, pharmaceuticals, manufacturing, automotive, and marine to name a few. Accordingly, the compact assembly of a safety gate valve is appealing, especially since it allows minimum space requirements. In addition, safety valves are particularly designed with extra heavy, rugged construction to ensure durability. As such, the safety gate valve is structured to protect pumps, compressors, pressure vessels or other piping systems that typically handle corrosive, flammable or high pressure/temperature liquids and gases. Additionally, safety gate valves function to monitor and manipulate the flow of liquids within a plurality of piping systems. Accordingly, they are generally structured to withstand intense pressure conditions within the flow passageways of the systems. An intense pressure event refers to any condition which would cause pressure in the system to increase beyond the specified design pressure or maximum allowable working pressure.

In addition, when in service, a safety gate valve can be either entirely open or closed depending on the requirement of flow within in a given environment. More specifically, in a pressure generating system, the safety valve must remain open at a predetermined set pressure, flow at a rated capacity at a specified overpressure, and close when the system pressure has returned to a safe level. Additionally, because of their ability to cut through and control most liquids, gate valves are highly effective and desirable in today's market. For instance, gate valves are designed in a manner in which they can monitor the flow of extremely viscous liquids. These may include oil, petroleum, propanol, benzene, grease, molasses and other flammable and non-flammable liquids. Accordingly, the oil and gas industry are more known industries, in which gate valves are preferably implemented. As such, oil and gas industries face complex burdens when it comes to their processes and applications. Restrictions range from operating conditions, profitability, budgets, environment hazards and safety guidelines. Accordingly, the oil and gas industries are under intense pressure to maintain safety guidelines within their processes. Perhaps that may be one of the reasons why gate valves are more preferable within the industries. Safety gate valves are inexpensively constructed, dynamically structured, and robustly designed to handle most pressurized conditions dealing with the most hazardous fluids and gases.

Furthermore, it important for safety gate valves that are switched off to absolutely restrict of liquid or gas through the pipe. This is important to avoid accidents, explosions, pollution, or the loss of valuable chemicals. However, most of the safety gate valves in today's market are subject to several deficiencies. Foremost amongst them is accidental openings. In particular, accidental openings of safety gate valves can be caused due to many external factors such as earthquakes, vibrations, tampering, or human error. As such, amongst the factors listed, human error is arguably the most unpredictable phenomena that leads to accidents. This is because ironically, even the most trained operators or managers of facilities can make unprecedented errors. Consequently, errors in decisions pertaining to readily opening of safety gate valves can lead to catastrophic results.

Safety gate valves are often exposed to external factors. As such, accidents relating to opening of safety gate valves are common and can occur anytime. For instance, during the course of trying to correct a process, an operator may inadvertently open the safety gate valve. Effectively, this course of action is especially vulnerable, if the safety gate valve that is opened does not feature added security measures. More specifically, if the valve opened is not associated with correcting the process, it could lead to disastrous results. Another example of this is when the operator of an oil piping system opens a safety gate valve controlling steam rather than oil in a given facility. As such, if the wrong valve is opened, the pipes can overheat and collapse causing the facility millions of dollars in damage, not to mention potential injuries to other operators and personnel in the facility. Consequently, occasional events as above-mentioned are unequivocal indicators that added security features in the safety gate valve are crucial, to curb some of the errors related to accidental safety gate valve openings.

Therefore, the market is in need of a safety gate valve that can be disposed in a safety orientation. As such, the disposition of the safety gate valve in the safety orientation can prevent it from accidental openings and therefore, minimize any collateral damage. Accordingly, the safety gate valve disposed in the safety orientation is highly required in the market to prevent injuries to personnel, maintain the integrity of the process, and minimize damage to surrounding environment.

### SUMMARY OF THE INVENTION

The invention is intended to present a solution to these and other needs which remain in the relevant field of art. As such, and for purposes of clarity in describing the structural and operative features in at least one preferred embodiment, the present invention is directed to a safety globe valve. The safety globe valve includes a housing, a stem and a body. To illustrate, the housing is disposed and dimensioned to include a hollow interior. The hollow interior of the housing is structured and disposed to accommodate at least a portion of the stem. As such, the stem is structured and disposed to pass through the housing. Accordingly, the stem is disposed within the hollow interior of the housing. The stem can be made of various materials, including but not limited to metal, plastic, rubber and polymer. Given this, in one of the preferred embodiments, the stem is dimensioned in a generally cylindrical configuration. Alternatively, the stem can also comprise of a variety of other configurations.

Furthermore, the housing of the safety globe valve is disposed to allow the stem to linearly move therein. As such, the linear movement of the stem within the hollow interior of the housing compliments the stem, when it is disposed in some of the preferred orientations of the present invention. These preferred orientations of the present invention will be discussed in greater detail below. Additionally, the housing can be made of a heavy duty construction, suitable to withstand intense temperatures and pressures. As such, the housing is structured and dimensioned in a generally cylindrical configuration. Alternatively, however, the housing can also be designed in various configurations, structured in various dimensions, and constructed of various materials.

Furthermore, in one of the preferred embodiments of the present invention, the hollow interior of the housing includes a space bushing. The space bushing is structured and disposed to minimize friction between the stem and the hollow interior of the housing. This is because absence of the space bushing within an embodiment can increase friction between the hollow interior of the housing and at least a portion of the stem, when the stem is disposed between some of the preferred orientations. As such, friction may limit the movement of the stem within the hollow interior of the housing, restricting it from being disposed in some of the preferred orientations.

In addition, the present invention comprises a body structured and disposed to allow flow of fluids and gases there through. More particularly, the body of the safety globe valve further comprises a flow passageway disposed and dimensioned to allow flow of fluids there through. Correspondingly, in other preferred embodiments, the body of the safety globe valve is connected to the housing and dimensioned to permit at least a portion of the stem to at least partially penetrate into the body's interior dimensions. Accordingly, the body can be made of various materials, including but not limited to metal, rubber, polymer or plastic.

Looking further, the stem of the present invention is disposed in a safety orientation. Accordingly, the safety orientation of the stem comprises at least first stem member in at least spaced apart relation to at least second stem member. To demonstrate this further, the safety orientation of the stem temporarily eliminates structural connectivity between at least first stem member and at least second stem member. As such, this may be sufficient to create at least an amount of space between the aforesaid stem members of the stem. Given this, the space between the stem members of the stem provides an added layer of protection against accidental openings of the safety globe valve of the present invention. As such, when the stem is disposed in the safety orientation, the safety globe valve is precluded from accidental openings that may be caused due to external factors such as human error. This is because, in one of the preferred embodiments, when the safety globe valve is correspondingly positioned to restrict the flow of fluids, the stem is preferably configured to be in the safety orientation. As such, at least first stem member is in spaced apart relation to at least second stem member. Accordingly, while in the spaced relation, the safety globe valve disposed to restrict the flow of fluids will not be affected by human error. This is because while in the spaced relation, at least first stem member is temporarily disconnected with at least second stem member. So then, and merely as an example, if any error accounts for an unintended push or other ill-advised interaction with at least first stem member, then at least second stem member will remain unaffected. This is because there is a lack of structural connectivity between the aforesaid stem members of the stem, while the stem is disposed in the safety orientation. So again, for instance and merely as an example, an operator of the safety globe valve would have to first dispose the stem from the safety orientation into another preferred orientation (which will be discussed below). Next, the operator would have to negotiate the stem further, preferably by rotating it in the direction opposite from the body, in order to alter the safety globe valve's “closed” position of restricting the flow of fluids. As such, disposing the stem first into another orientation and then having to negotiate the stem rotationally, adds extra layer of protection from accidental openings. Consequently, additional structural features of this invention including other preferable orientations that the stem can be disposed into, will be discussed in greater detail below.

Furthermore, the stem is disposed in an operative orientation. More specifically, the operative orientation includes at least first stem member in at least temporarily connected relation to at least second stem member. As such, when the stem is disposed in the operative orientation, at least first stem member is temporarily connected to at least second stem member. More specifically, in order to dispose the stem in the operative position, at least first stem member is advanced in the direction of at least second member. Further, the advancing of at least first stem member in the direction of at least second member continues until at least first stem member is temporarily connected to at least second stem member.

To further demonstrate the aforesaid, each of at least first stem member and at least second stem member comprise a connector assembly. More specifically, the connector assembly includes at least two connecting members, wherein one of at least two connecting members is disposed on a different one of at least first stem member and at least second stem member in communicating, accessible relation with each other. Particularly, the connecting assembly removably connects or couples at least first stem member to at least second stem member in order for the members of the stem to remain temporarily connected to each other. To further demonstrate, in one of the exemplary embodiments, each of the connecting members include at least a spline, and more precisely, a male spline assembly and a female spline assembly. As such, the male spline assembly and the female spline assembly allow a removable mating engagement there in between featured by a linear movement. More specifically, the male spline assembly and the female spline assembly, each comprise an equally spaced grooves around their respective circumferences. The groves are generally parallel in relation to each of the corresponding portions of the stem. As such, the external grooves of the male spline assembly couple with the internal slots formed in reverse configuration to the female spline assembly's grooves when advanced in the linear movement, thus maintaining a communicating relationship there in between. Accordingly, this enables the connecting members of the connecting assembly to remain mated, allowing the members of the stem to at least temporarily remain connected to each other, while in the operative orientation.

Furthermore, the present invention comprises an actuator. As such, the actuator primarily functions as a mechanical equipment to supply a predetermined amount of force necessary to “open” or “close” the safety globe valve. Accordingly, the method of applying force to the safety globe valve is what differentiates the various types of actuators. In one preferred embodiment, the actuator can comprise a manual mechanism for “opening” and “closing” the safety globe valve such as a lever or turn wheel. To further emphasize, the actuator can be manually negotiated to “open” the safety globe valve, allowing fluids to freely flow through the flow passageway of the body without any interference from the safety globe valve. Similarly, the actuator can also be manually negotiated to “close” the safety globe valve, restricting fluids to freely flow through the flow passageway of the body. Alternatively, in other embodiments, the actuator can be any form of automated mechanism such as pneumatic, hydraulic or electric, requiring no manual intervention.

Given all this, the actuator is structured and disposed to advance at least first stem member in the direction of at least second stem member, when a predetermined amount of force is applied on the actuator. More specifically, the actuator is connected to at least first stem member. As such, once the predetermined amount of force is applied on the actuator, the actuator disposes at least first stem member towards at least second stem member. Consequently, the force is continued to be applied on the actuator, sufficient to dispose the stem in the aforesaid operative position. To explain this in detail, as at least first stem member is disposed in the direction of at least second stem member, the spaced apart relation between the members of the stem continues to diminish, until at least first stem member couples with at least second stem member. Subsequently, at least first stem member is temporarily connected with at least second stem member to define the stem in the aforesaid operative orientation.

Furthermore, the actuator is structured and disposed to rotationally advance the stem in the direction of the body, while the stem is disposed in the operative orientation. Accordingly, in one preferred embodiment, the stem and an inner wall of the hollow interior of the housing are at least partially threaded. To further demonstrate, the external threads on the stem are disposed to threadbly mate with the internal threads on the inner wall of the hollow interior of the housing. Accordingly, the threadable engagement between the stem and the inner wall of the hollow interior of the housing allows the stem disposed in the operative orientation to further advance in the direction of the body. More specifically, the actuator is connected to the stem, while the stem is disposed in the aforesaid operative orientation. As such, the actuator further negotiated rotationally, so as to allow the stem to rotationally dispose itself in the direction of the body. Consequently, the stem is sufficiently rotated in the direction of the body, until the safety globe valve is in “closed” position, restricting the flow of fluids in the flow passageway of the body.

Similarly, the actuator is structured to rotationally dispose the stem in opposite direction relative to the body, while the stem is disposed in the aforesaid operative orientation. To further demonstrate, the actuator, while in the operative orientation, is negotiated rotationally to dispose the stem rotationally in opposite direction relative to the body. Consequently, the stem is sufficiently rotated to dispose it in the direction opposite of the body, until the safety globe valve is “opened”, allowing the flow of fluids in the flow passageway of the body.

Looking further, the present invention comprises a biasing member. As such, the biasing member is structured and disposed to retract and compress in some of the exemplary embodiments. Accordingly, the biasing member is connected to the stem and disposed for biasing at least first stem member in spaced relation to at least second stem member. More specifically, the biasing member has retracting characteristics, which permit the biasing member to exercise its retracting force, sufficient to dispose at least first stem member in spaced relation to at least second stem member. For instance, as soon as at least first stem member is disconnected from its temporary connection with at least second stem member, the biasing member immediately uses its retracting force to retract at least first stem member in spaced relation to at least second stem member. Consequently, this defines the stem of the safety globe valve in the safety orientation, as it has been disclosed in detail above.

Additionally, in one of the other exemplary embodiments, the biasing member is disposed to compress. As such, when force is applied on the actuator, the biasing member compresses. More specifically, the actuator is connected to at first stem member. Correspondingly, at least first stem member is connected to the biasing member. As such, the force applied on the actuator disposes at least first stem member in temporarily connected relation to at second stem member. More specifically, the ability of the biasing member to compress allows at least first stem member to be disposed in removably connected relation to at least second stem member. Consequently, this defines the stem of the safety globe valve in the operative orientation as it is disclosed in detail above.

Additionally, the present invention comprises a locking member. The locking member is structured and disposed to secure the actuator, when the stem is disposed in the safety orientation. As such, the locking member provides an extra layer of protection from accidental opening of the safety globe valve, when the stem of is disposed in the safety orientation.

Next, the method of preventing a safety globe valve including a stem and a body from accidental openings comprises disposing at least first stem member in the direction of at second stem member. More specifically, in order to dispose at least first stem member in the direction of at least second stem member, the actuator connected to the stem is first activated by applying predetermined force on it. Given this, when force is applied, at least first stem member begins to dispose in direction of at least second stem member. So then, as force is continued to be applied on the actuator, the biasing member, which is at least partially connected to the stem, disposes at least first stem member more and more in the direction of at least second stem member. More specifically, the biasing member has compressing characteristics. As such, the ability of the biasing member to compress allows at least first stem member to dispose in the direction of at least second stem member, when force is applied on the actuator.

Next, in one of the preferred embodiments of the present invention, the method of preventing a safety globe valve including a stem and a body from accidental openings comprises coupling at least first stem member to at least second stem member to create a temporarily connected relation there in between. More specifically, each of at least first stem member and at least second stem member have connecting members disposed thereon. As such, the connecting members mate or couple with each other, when at least first stem member is at least temporary connected to at least second stem member, defining the stem in the operative orientation.

Further, the method of preventing a safety globe valve including a stem and a body from accidental openings further comprises disposing the stem in direction of the body and in direction opposite from the body, while the stem is disposed in the operative orientation. To further demonstrate, the actuator rotationally advances the stem in direction of the body, while the stem is disposed in the operative orientation. More specifically, the threaded, mating engagement between the stem and the inner wall of the hollow interior of the housing, permits the stem disposed in the operative orientation to further rotationally dispose in the direction of the body, as the actuator is rotationally disposed, until the safety globe valve is “closed”. Similarly, the actuator rotationally disposes the stem in direction opposite from the body, while the stem is disposed in the operative orientation. This is because the threadable engagement between the stem and the inner wall of the hollow interior of the housing, allows the stem disposed in the operative orientation, to rotationally dispose in the direction opposite of the body, as the actuator is rotationally disposed, until the safety globe valve is “opened”.

Furthermore, in one of the other exemplary embodiments of the present invention, the method of preventing a safety globe valve including a stem and a body from accidental openings comprises uncoupling at least first stem member from at least second stem member to create a spaced apart relation between at first stem member and at least second stem member. Given this, the spaced apart relation between at least first stem member and at least second stem member defines the stem in the safety orientation. More specifically, once the stem is disposed in the direction opposite from the body until the safety globe is opened, at least first stem member is disengaged from its temporary connection with at least second stem member. The disengagement immediately creates a spaced apart relation between at least first stem member and at least second stem member. More specifically, the biasing member is biased to retract at least first stem member in direction opposite to at least second stem member. As such, when at least first stem is disengaged from its connection with at least second stem member, the biasing member retracts, biasing at least first stem member to retract in the direction opposite to at least second stem member. Accordingly, as at least first stem member retracts away from the at least second stem member, the spaced apart relation between the aforesaid members of the stem continues to increase, until the stem is finally defined in the safety position.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of the present invention illustrating the stem disposed in the safety orientation in accordance to one of the preferred embodiments.

FIG. 2 is a perspective view of the present invention illustrating the stem disposed in the operative orientation in accordance to one of the preferred embodiments.

FIG. 3 is a perspective view of the present invention illustrating the rotational negotiation of the actuator, disposing the stem in the direction opposite to the body in accordance to one of the preferred embodiments.

FIG. 4A is a schematic view of the present invention illustrating the stem disposed in the safety orientation in accordance to one of the preferred embodiments.

FIG. 4B is a schematic view of the present invention illustrating the stem disposed in the operative orientation in accordance to one of the preferred embodiments.

FIG. 4C is a schematic view of the present invention illustrating the actuator rotationally disposing the stem, while the stem is in the operative orientation in accordance to one of the preferred embodiments.

FIG. 4D is a schematic view of the present invention illustrating the actuator's rotational disposition of the stem, while the stem is in the operative orientation, sufficient to allow flow of fluids through the body in accordance to one of the preferred embodiments.

FIG. 5 is a flow chart of the method of the present invention for preventing accidental openings in accordance to one of the preferred embodiments.

Like reference numerals refer to like parts throughout the several views of the drawings.

### DETAILED DESCRIPTION OF THE PREFERRED EMBODIMENT

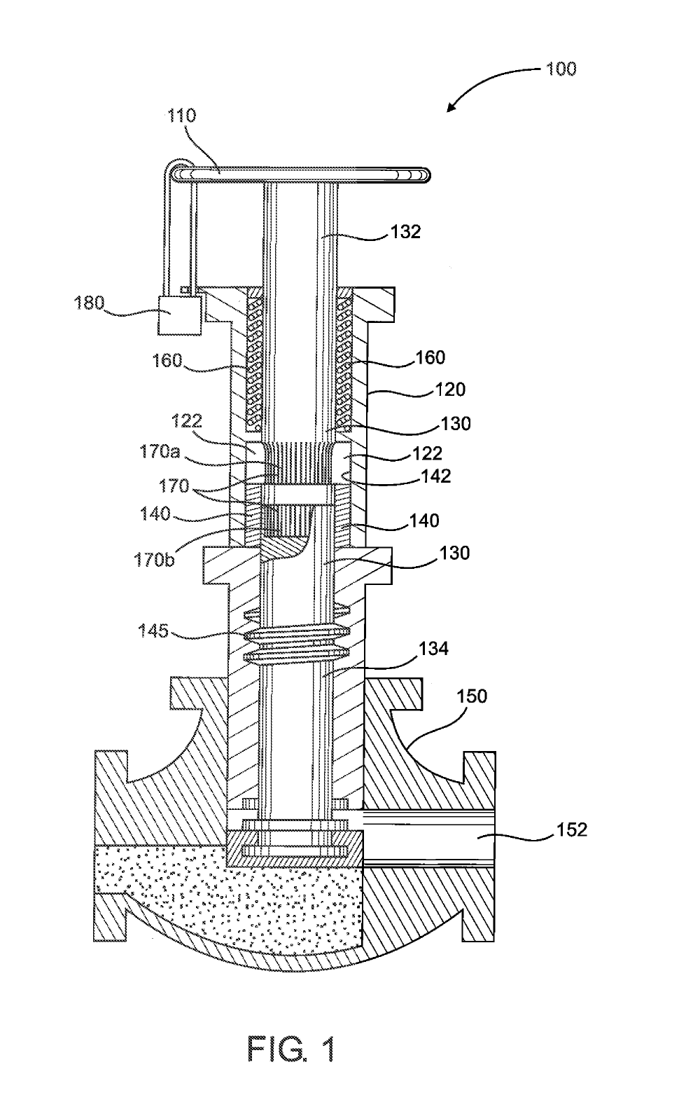

As shown in the accompanying drawings, the present invention of a safety globe valve is generally directed to a housing, a stem and a body. Accordingly, referring to FIG. 1, in one of the preferred embodiments, the housing 120 is disposed and dimensioned to include a hollow interior 122. The hollow interior 122 of the housing 120 is structured and disposed to accommodate at least a portion of the stem 130. Given this, the stem 130 is disposed within the hollow interior 122 of the housing 120. Additionally, the housing 120 of the safety globe valve 100 is disposed to allow the stem 130 to linearly move within the hollow interior 122 of the housing 120. As such, the ability of the stem to linearly move 130 within the hollow interior 122 of the housing 120 allows the stem 130 to move more readily, when it is disposed between some of preferred orientations of the present invention. As such, the preferred orientations will be discussed subsequently in greater detail. Furthermore, the housing 120 can be made of a heavy duty construction, suitable to withstand intense temperatures and pressures. As such, the housing 120 comprise various configurations, dimensions, and materials, however, in one of the preferred embodiments, it is structured in a generally cylindrical configuration.

Referring again to FIG. 1, in one of the preferred embodiments of the present invention, the hollow interior 122 of the housing 120 includes a space bushing 140. The space bushing 140 is structured and disposed to minimize friction between the stem 130 and an inner wall 142 of the hollow interior 122 of the housing 120. This may be because the absence of the space bushing 140 in one of the embodiments may increase friction between the inner wall 142 of the hollow interior 122 of the housing 120 and at least a portion of the stem 130, when the stem 130 is disposed between some of the preferred orientations of the present invention.

Looking further into FIGS. 1, 2 and 3, in other preferred embodiments as shown, the present invention comprises a body 150 structured and disposed to allow the flow of fluids and gases there through. In particular, the body 150 of the safety globe valve 100 comprises a flow passageway 152 disposed and dimensioned to allow flow of fluids there through. Correspondingly, in other preferred embodiments, the body 150 is connected to the housing 120 and dimensioned to permit at least a portion of the stem 130 to at least partially penetrate into the body's 150 interior dimensions. As a result, the body 150 can be made of various materials, including but not limited to metal, rubber, polymer or plastic.

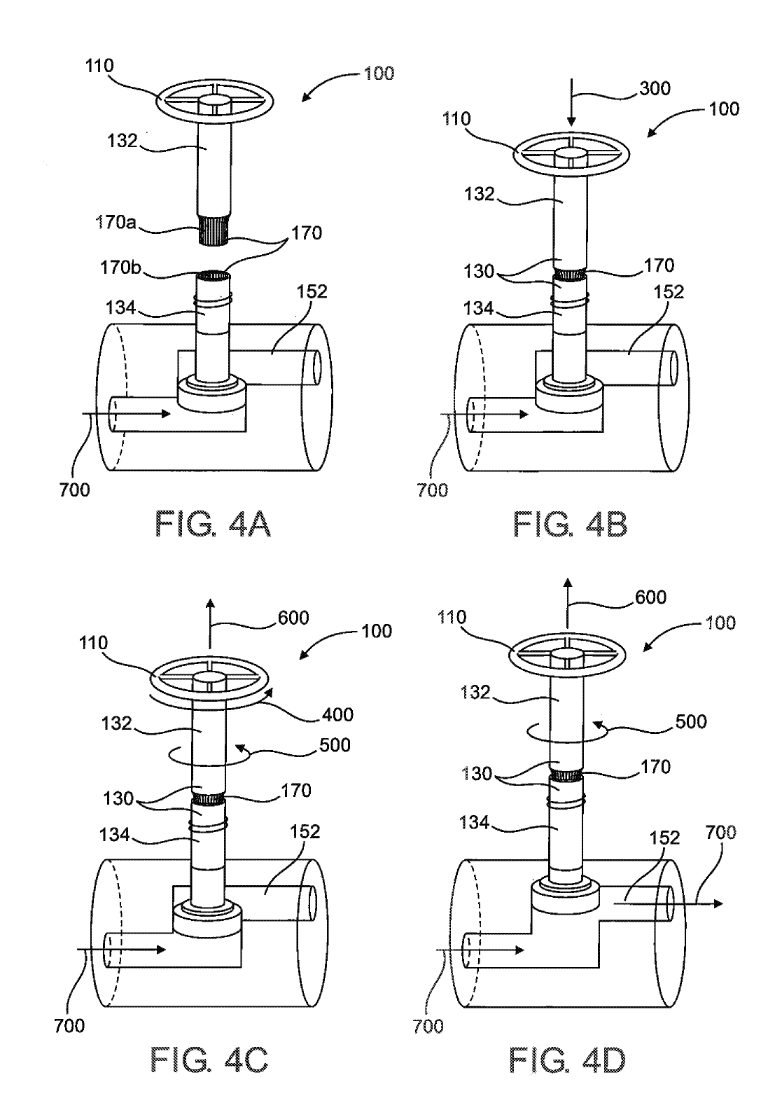

Referring now to FIG. 1 and FIG. 4A, in accordance to one of the exemplary embodiments, the stem 130 of the present invention is disposed in a safety orientation. Accordingly, the safety orientation of the stem 130 comprises at least first stem member 132 in at least spaced apart relation to at least second stem member 134. To demonstrate this further, the safety orientation of the stem 130 temporarily eliminates structural connectivity between at least first stem member 132 and at least second stem member 134. As such, this creates at least an amount of space between the aforesaid stem members 132, 134 of the stem 130. Resultantly, the space between the stem members 132, 134 of the stem 130 as illustrated in FIGS. 1 and 4A, provides an added layer of protection against accidental openings of the safety globe valve 100. As such, when the stem 130 is disposed in the safety orientation, the safety globe valve 100 is precluded from accidental openings caused due to external factors such as human error. For instance, in one of the preferred embodiments, when the safety globe valve 100 is correspondingly positioned to restrict the flow of fluids, the stem 130 is preferably configured to be in the safety orientation as shown in FIGS. 1 and 4A. As such, at least first stem member 132 is in spaced apart relation to at least second stem member 134. Accordingly, while in the spaced relation, the safety globe valve 100 is generally immune to accidental openings due to human error. This is because while in the safety orientation, at least first stem member 132 is temporarily disconnected with at least second stem 134 member. So, as a consequence, if a human error results in the course of action such as pushing or turning to accidentally open at least first stem member 132, such action(s) will not readily affect at least second stem member 134 of the stem 130. This is because the lack of structural connectivity between the aforesaid stem members 132, 134 as shown in FIGS. 1 and 4A, provides an extra layer of protection against accidental openings, while the stem 130 is disposed in the safety orientation. To further illustrate, if the stem 130 was disposed in the safety orientation, an operator of the safety globe valve 100 would have to first dispose the stem 130 from the safety orientation into another orientation (as discussed in detail below). Next, while in another orientation, the operator would then have to further negotiate the stem 130, in the direction opposite from the body 150 in order to manipulate the safety globe valve's 100 “closed” position of restricting the flow of fluids as shown in FIGS. 4C and 4D. Resultantly, the safety orientation of the stem 130 adds an extra layer of protection, preventing the safety globe valve from accidental openings. Accordingly, another orientation that the stem 130 can be disposed into will be discussed in greater detail below.

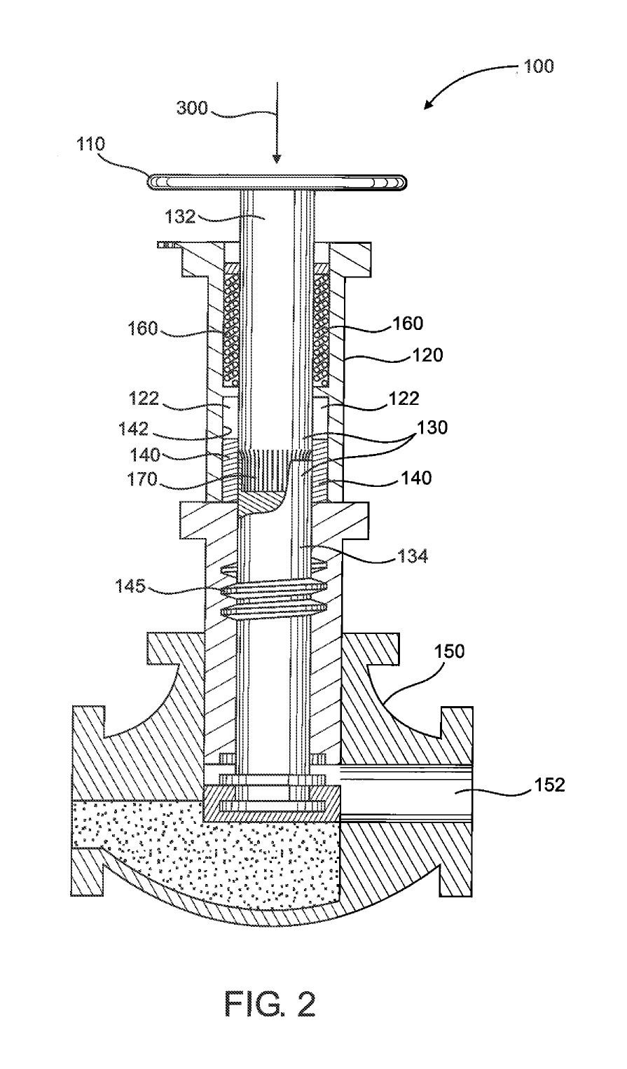

Referring now to FIG. 2, in one of the preferred embodiments of the present invention, the stem 130 is disposed in an operative orientation. More specifically, FIG. 2 shows the operative orientation includes at least first stem member 132 in at least temporarily connected relation to at least second stem member 134. As such, when the stem 130 is disposed in the operative orientation, at least first stem member 132 is temporarily connected to at least second stem member 134 as shown in FIG. 2. More specifically and referring now to FIGS. 2 and 4B, in order to dispose the stem in the operative position, at least first stem member 132 is advanced in the direction of at least second member 134. The advancing of at least first stem member in the direction of at least second member 134 continues until at least first stem 132 member is temporarily connected to at least second stem member 134 as shown in FIG. 2. More specifically, each of at least first stem member 132 and at least second stem member 134 comprise a connector assembly 170 as illustrated in FIGS. 1, 2 and 3. The connector assembly 170 includes at least two connecting members 170a, 170b, wherein one of at least two connecting members 170a, 170b is disposed on a different one of at least first stem member 132 and at least second stem member 134 in communicating, accessible relation with each other as shown in FIG. 1. Particularly, the connecting assembly 170 removably connects or couples at least first stem member 132 to at least second stem member 134 in order for the members 132, 134 of the stem 140 to remain temporarily connected to each other.

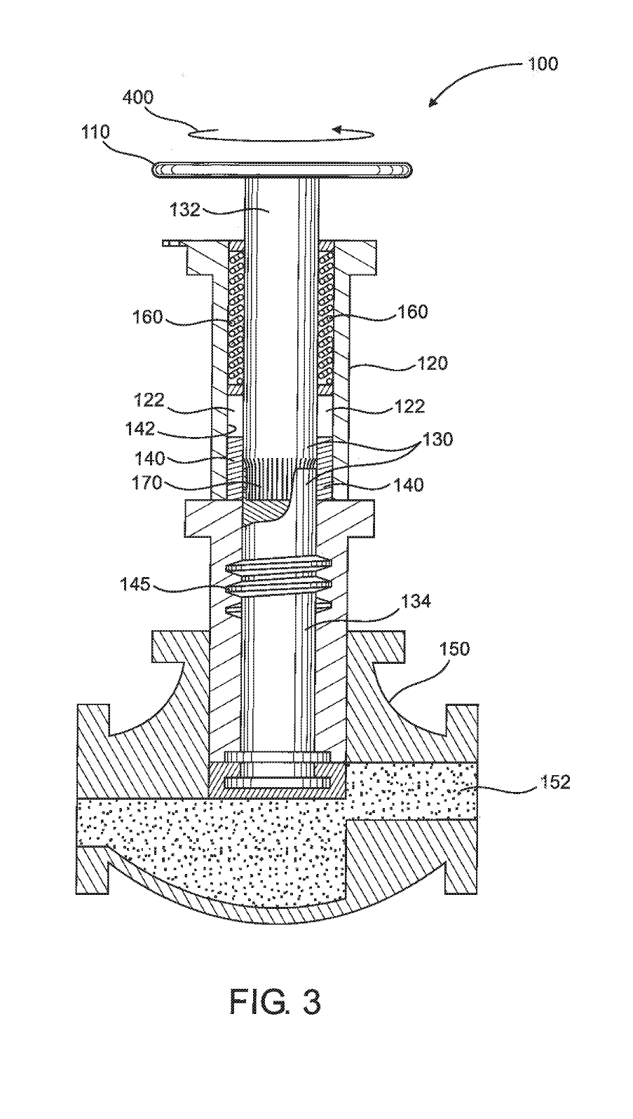

Additionally, in accordance to one of the preferred embodiments, and merely as an example, each of the connecting members 170a, 170b may include at least a spline, and more precisely, a male spline assembly 170a and a female spline assembly 170b. As such, in this preferred embodiment, the male spline assembly 170a and the female spline assembly 170b allow a removable mating engagement there in between featured by a linear movement. More specifically, the male spline assembly 170a and the female spline assembly 170b, each comprise an equally spaced grooves around their respective circumferences. The groves are generally parallel in relation to each of the corresponding portions of the stem. As such, the external grooves of the male spline assembly 170a couple with the internal slots formed in reverse configuration to the female spline assembly's grooves, when the external grooves are advanced in the linear movement, thus maintaining a connecting relationship there in between. Accordingly, this allows the members 132, 134 of the stem 130 to remain temporarily connected to each other, while in the operative orientation. Furthermore, the connecting members 170a, 170b of the connecting assembly 170 allow the stems 132, 134 to remain mated, as the stem 130 is rotationally disposed to open or close the safety globe valve 100 in other preferred embodiments as shown in FIGS. 3, 4C, and 4D.

Furthermore, referring to all Figures, in one of the preferred embodiments, the present invention comprises an actuator 110. As such, the actuator 110 primarily functions as a mechanical equipment to supply a predetermined amount of force necessary to “open” or “close” the safety globe valve 100. Accordingly, the method of applying force to the safety globe valve 100 is what differentiates the various types of actuators. In one preferred embodiment as shown in FIGS. 4C and 4D, the actuator 100 can comprise a manual mechanism for “opening” and “closing” the safety globe valve 100 such as a lever or turn wheel. Accordingly, the actuator 110 can be manually negotiated to “open” the safety globe valve 100, allowing fluids to freely flow through the flow passageway 152 of the body 150. Similarly, the actuator 110 can also be manually negotiated to “close” the safety globe valve 100, restricting fluids to freely flow through the flow passageway 152 of the body 150. Alternatively, in other embodiments, the actuator 110 can be any form of automated mechanism such as pneumatic, hydraulic or electric, requiring no manual intervention (not shown).

Referring now to FIGS. 2 and 4B, the actuator 110 is structured and disposed to advance at least first stem member 132 in the direction of at least second stem member 134, when a predetermined amount of force indicated by directional arrow 300 is applied on the actuator 110. More specifically, the actuator 110 is connected to at least first stem member 132 as shown in all Figures. As such, once the predetermined amount of force indicated by directional arrow 300 is applied on the actuator 110, the actuator 110 disposes at least first stem member 132 towards at least second stem member 134 as shown in FIGS. 2 and 4B. Consequently, the force as indicated by directional arrow 300 is continued to be applied on the actuator 110, sufficient to dispose the stem 130 in the aforesaid operative position. More specifically, as at least first stem member 132 is disposed in the direction of at least second stem member 134, the spaced apart relation between the members 132, 134 of the stem 130 as shown in FIGS. 1 and 4A, continues to diminish, until at least first stem member 132 couples with at least second stem member 134 as shown in FIGS. 2 and 4B. Subsequently then, and again as illustrated in FIG. 2, at least first stem member 132 is temporarily connected with at least second stem member 134 to define the stem in the aforesaid operative orientation.

Referring now to FIGS. 3, 4C and 4D, the actuator 110 is structured to rotationally dispose the stem 130 in opposite direction relative to the body 150, while the stem 130 is disposed in the operative orientation. More specifically, the actuator 110 is connected to the stem 130, while the stem 130 is disposed in the aforesaid operative orientation. Accordingly, in one of the preferred embodiments as illustrated in FIG. 3, the stem 130 and an inner wall 142 of the hollow interior 122 of the housing 120 are at least partially threaded. As such, the external threads on the stem 130 are disposed in a threadable engagement 145 with the internal threads on the inner wall 142 of the hollow interior 122 of the housing 120, so as to allow the stem 130 to dispose rotationally. So then, the actuator 110, while in the operative orientation, is negotiated rotationally as indicated by directional arrow 400 in FIG. 3, to dispose the stem 130 rotationally in opposite direction relative to the body 150. Consequently, the stem 130 is sufficiently rotated, until the safety globe valve 100 is in “open” position, allowing the flow of fluids in the flow passageway 152 of the body 150 as illustrated in FIG. 3.

Similarly, in one of the other preferred embodiments (not shown) the actuator 110 is structured and disposed to rotationally advance the stem in the direction of the body 150, while the stem 30 is disposed in the operative orientation. Accordingly, the threadable engagement 145 between the stem and the inner wall 142 of the hollow interior 122 of the housing 120 allows the stem 130 disposed in the operative orientation to further advance in the direction of the body 150. As such, the actuator 110 is negotiated rotationally, so as to allow the stem 120 to rotationally dispose itself in the direction of the body 150, until the safety globe valve is in “close” position, restricting the flow of fluids through the flow passageway 152 of the body 150.

Next, referring to FIGS. 1, 2 and 3, the present invention comprises a biasing member 160 in accordance to one of the preferred embodiments. As such, the biasing member 160 is structured and disposed to retract and compress. Accordingly, the biasing member 160 is connected to the stem 130 and disposed to bias at least first stem member 132 in spaced relation to at least second stem member 134. More specifically, the biasing member 160 has retracting characteristics, which permit it to exercise its retracting force, sufficient to dispose at least first stem member 132 in spaced relation to at least second stem member 134 as illustrated in FIG. 1. For instance, as soon as at least first stem member 132 is disconnected from its temporary connection with at least second stem member 134, the biasing member 160 immediately uses its retracting force to retract at least first stem member 132 in spaced relation to at least second stem member 134. Consequently, this defines the stem 130 of the safety globe valve 100 in the safety orientation, as illustrated in FIG. 1.

Referring now to FIGS. 2 and 3, in one of the other exemplary embodiments, the biasing member 160 is disposed to compress when the predetermined force as indicated by directional arrow 300 is applied on the actuator 110. More specifically, the actuator 110 is connected to at first stem member 132 as shown in all Figures. Correspondingly, as illustrated in FIGS. 1, 2 and 3, at least first stem member 132 is at least partially connected to the biasing member 160. As such, the predetermined force applied on the actuator as indicated by direction arrow 300 in FIG. 2, disposes at least first stem member 132 in temporarily connected relation to at second stem member 134. More specifically, the ability of the biasing member 160 to compress allows at least first stem member 132 to be disposed in removably connected relation to at least second stem member 134. Consequently, this defines the stem 130 of the safety globe valve 100 in the operative orientation as illustrated in FIG. 2.

Referring back to FIG. 1, in accordance to one of the preferred embodiments, the present invention comprises a locking member 180. The locking member 180 is structured and disposed to removably secure the actuator 110, so as to restrict its movement, when the stem 130 is disposed in the safety orientation to a portion of the housing 120. As such, the locking member 180 provides extra level of protection by at least partially restricting the actuator 110 from disposing the stem 130 in between the aforesaid orientations, especially when the stem 130 is disposed in the safety orientation as illustrated in FIG. 1.

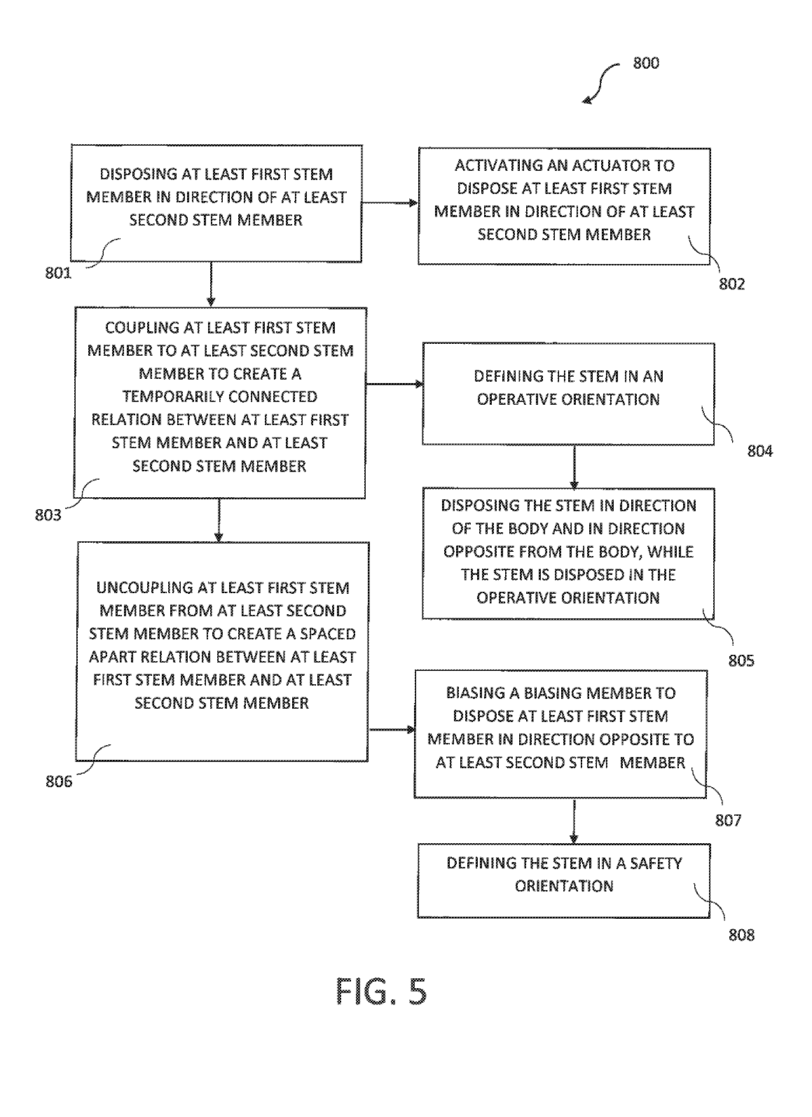

Next, referring now to FIG. 5, the method 800 of preventing a safety globe valve 100 including a stem 130 and a body 150 from accidental openings comprises disposing at least first stem member 132 in the direction of at second stem member 134 as illustrated in step 801. More specifically in step 801, in order to dispose at least first stem member 132 in the direction of at least second stem member 134, the actuator 110 connected to the stem 130 is activated to dispose at least first stem member 132 in direction of at least second stem member 134 as illustrated in step 802. As such, the actuator 110 is activated by applying a predetermined force on the actuator 110. Given this, when force is applied, at least first stem member 132 begins to dispose in direction of at least second stem member 134. So then, as force is continued to be applied on the actuator 110, the biasing member 160, which is at connected to the stem 130 compresses, allowing at least first stem member 132 to dispose in the direction of at least second stem member 134. More specifically, the biasing member 160 has compressing characteristics. As such, the ability of the biasing member 160 to compress allows at least first stem member 132 to dispose in the direction of at least second stem member 134, when force is applied on the actuator 110. Accordingly, disposing at least first stem member 132 in the direction of at least second stem member 134 diminishes the spaced apart relation there in between until at least first stem member 32 begins to couple with at least second stem member 134.

Given this, and now referring again to FIG. 5, in one of the preferred embodiments of the present invention, the method 800 of preventing a safety globe valve 100 including a stem 130 and a body 150 from accidental openings comprises coupling at least first stem member 132 to at least second stem member 134 to create a temporarily connected relation there in between as illustrated in step 803. More specifically, each of at least first stem member 132 and at least second stem member 134 have connecting members 170a, 170b disposed thereon. As such, the connecting members 170a, 170b mate or couple with each other, when at least first stem member 132 is at least temporary connected to at least second stem member 134, defining the stem 130 in the operative orientation as indicated in step 804.

Further, referring again to FIG. 5, the method 800 of preventing a safety globe valve 100 including a stem 130 and a body 150 from accidental openings further comprises disposing the stem 130 in direction of the body 150 and in direction opposite from the body 150, while the stem 130 is disposed in the operative orientation as shown in step 805. To further demonstrate, the actuator 110 rotationally advances the stem 130 in direction of the body 150, while the stem 150 is disposed in the operative orientation. More specifically, the threaded, mating engagement 145 between the stem 130 and the inner wall 142 of the hollow interior 122 of the housing 120, permits the stem 130 disposed in the operative orientation to further rotationally dispose in the direction of the body 150, as the actuator 110 is rotationally disposed, until the safety globe valve 100 is “closed”. Similarly, the actuator 110 rotationally disposes the stem 130 in direction opposite from the body 150, while the stem 130 is disposed in the operative orientation. This is because the threadable engagement 145 between the stem 130 and the inner wall 142 of the hollow 122 interior of the housing 120, allows the stem 130 disposed in the operative orientation, to rotationally dispose in the direction opposite of the body 150, as the actuator 110 is rotationally disposed, until the safety globe valve 100 is “opened”.

Furthermore, referring to FIG. 5, in one of the other exemplary embodiments of the present invention, the method 800 of preventing a safety globe valve 100 including a stem and a body from accidental openings comprises uncoupling at least first stem member 132 from at least second stem member 134 to create a spaced apart relation between at least first stem member 132 and at least second stem member 134 as illustrated in step 806. More specifically, the connecting members 170a, 170b are disposed on different one of at least first stem member 132 and at least second stem member 134. As such, in one of the preferred embodiments, the connecting members 170a, 170b can be represented as male spline assembly 170a and a female spline assembly 170b. The spline assemblies 170a, 170b are disengaged out of their mating relationship, in order to uncouple at least first member 132 from at least second stem member 134 as illustrated in step 806. Next, the biasing member 160 is biased to dispose at least first stem member 132 in direction opposite to at least second stem member 134 as illustrated in step 807. As such, the biasing member 160 is connected to the stem 130. Given all this, in one of the preferred embodiments, as soon as the connecting members 170a, 170b are disengaged, the stems 132, 134 are disposed to create the spaced apart relation between at least first stem member 132 and at least second stem member 134 allowed by the retracting force of the biasing member 160. More specifically, once the stem 130 is disposed in the direction opposite from the body 150, opening the safety globe valve 100, at least first stem 132 member is disengaged from its temporary connection with at least second stem member 134. The disengagement immediately creates a spaced apart relation between at least first stem member 132 and at least second stem member 134. As such, when at least first stem 132 is disengaged from its connection with at least second stem member 134, the biasing member 160 retracts, biasing at least first stem member 132 to retract in the direction opposite to at least second stem member 134. Given this, the biasing member 160 is biased to retract at least first stem member 132 in direction opposite to at least second stem member 134 as indicated in 807. Accordingly, as at least first stem member 132 retracts away from the at least second stem member 134, the spaced apart relation between the aforesaid members 132, 134 of the stem continues to increase, until the stem 130 is finally defined in the safety position as illustrated in step 808.

Any of the above methods may be completed in sequential order in at least one preferred embodiment, though they may be completed in any other order in other preferred embodiments. In at least one of the preferred embodiments, the above methods may be exclusively performed, but in other preferred embodiments, one or more steps of the methods as described may be skipped.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A safety globe valve comprising:
a housing,
a stem disposed within a hollow interior of said housing and disposed in a safety orientation, and
said safety orientation comprising at least first stem member disposed in at least spaced apart relation to at least second stem member.

2. The safety globe valve as recited in claim 1 wherein said stem is disposed in an operative orientation comprising said at first stem member in at least temporarily connected relation to said at least second stem member.

3. The safety globe valve as recited in claim 1 wherein said at least first stem member is structured to retract in direction opposite to said at least second stem member, upon disposing said stem in said safety orientation.

4. The safety globe valve as recited in claim 3 wherein said at least first stem member is structured to dispose in direction of said at least second stem member, sufficient to dispose said stem in said operative orientation.

5. The safety globe valve as recited in claim 1 further comprising a connecting assembly, wherein said connecting assembly defining at least two connecting members.

6. The safety globe valve as recited in claim 5, wherein each of said at least two connecting members are disposed on a different one of at least first stem member and at least second stem member in a communicating, accessible relation with each other.

7. The safety globe valve as recited in claim 1 further comprising an actuator structured and disposed to advance said at least first stem member in direction of said at least second stem member, when a predetermined amount of force is applied on said actuator.

8. The safety globe valve as recited in claim 7, wherein said actuator is structured and disposed to rotationally advance said stem in direction of said body, while said stem is disposed in said operative orientation.

9. The safety globe valve as recited in claim 6 wherein said actuator is structured and disposed to rotationally advance said stem in direction opposite to said body, while said stem is disposed in said operative orientation.

10. The safety valve as recited in claim 1 further comprising a body structured and disposed to allow flow of fluids and gases.

11. A safety globe valve comprising:
a housing,
a stem disposed within a hollow interior of said housing,
said stem comprising at least first stem member and at least second stem member,
said stem disposable between a safety orientation and an operative orientation,
said safety orientation defining said at least first stem member in spaced relation with said at least second stem member, and
said operative position defining said at least first stem member in temporarily connected relation with said at least second stem member.

12. The safety globe valve as recited in claim 11 further comprising a biasing member structured and disposed for biasing said at least first stem member in said spaced relation with said at least second stem member.

13. The safety globe valve as recited in claim 12 wherein said biasing member structured and disposed to compress, sufficient to allow said at least first stem member to dispose in direction of said at least second stem member.

14. The safety globe valve as recited in claim 13 wherein said biasing member is at least partially connected to said stem.

15. The safety globe valve as recited in claim 11 wherein each of said at least first stem member and said at least second stem member defining at least one connecting member.

16. The safety globe valve as recited in claim 11 wherein said stem is structured and disposed to threadably engage with at least a portion of an inner wall of said housing.

17. A method of preventing a safety globe valve including a stem and a body from accidental openings comprising:
disposing at least first stem member in direction of at least second stem member,
coupling at least first stem member to at least second stem member to create a temporarily connected relation between at least first stem member and at least second stem member, and
uncoupling at least first stem member from at least second stem member to create a spaced apart relation between at least first stem member and at least second stem member.

18. The method as recited in claim 17 further comprising activating an actuator to dispose at least first stem member in direction of at least second stem member.

19. The method as recited in claim 18, wherein the actuator is at least partially connected to the stem.

20. The method as recited in claim 17 further comprising biasing a biasing member to dispose at least first stem member in direction opposite to at least second stem member.

21. The method as recited in claim 20, wherein the biasing member is at least partially connected to the stem.

22. The method as recited in claim 17 further comprising defining the stem in an operative orientation.

23. The method as recited in claim 22 wherein the operative orientation comprising at least first stem member in at least temporarily coupled relation with at least second stem member.

24. The method as recited in claim 17 further comprising disposing the stem in direction of the body and in direction opposite from the body, while the stem is disposed in the operative orientation.

25. The method as recited in claim 17 further comprising defining the stem in a safety orientation.

26. The method as recited in 25 wherein the safety orientation comprises at least first stem member in at least spaced apart relation to at least second stem member.
